(19) United States
(12) Patent Application Publication
(10) Pub. No.: US 2009/0307741 A1
(43) Pub. Date: Dec. 10, 2009

(54) METHODS AND APPARATUS FOR DIVIDING AN AUDIO/VIDEO STREAM INTO MULTIPLE SEGMENTS USING TEXT DATA

(75) Inventor: Steven M. Casagrande, Castle Rock, CO (US)

Correspondence Address: EchoStar Technologies, L.L.C.;Legal Department, 9601 SOUTH MERIDIAN BOULEVARD, ENGLEWOOD, CO, 80112, US

(73) Assignee: EchoStar Technologies L.L.C., Englewood, CO (US)

(21) Appl. No.: 12/135,360

(22) Filed: Jun. 9, 2008

(51) Int. Cl. H04N 7/08

(52) U.S. Cl. 725/137

(57) ABSTRACT

Various embodiments of apparatus and/or methods are described for identifying multiple segments of content in a recorded audio/video stream. Thus, an audio/video stream may be segmented into various logical chapters, scenes or other sections and the like. The segments of the audio/video stream may then be selectably viewed by a user. A DVR presents the selected segments and automatically skips over the undesignated segment of the audio/video stream.

### BACKGROUND

Digital video recorders (DVRs) and personal video recorders (PVRs) allow viewers to record video in a digital format to a disk drive or other type of storage medium for later playback. DVRs are often incorporated into set-top boxes for satellite and cable television services. A television program stored on a set-top box allows a viewer to perform time shifting functions, (e.g., watch a television program at a different time than it was originally broadcast). However, most users do not desire to watch all of the content in a recorded video stream. For example, a user watching the evening news may not desire to see every segment of the news. However, the user is not able to simply select which portions of the news show that they desire to view. Rather, the user begins sequential playback of the news program, and then manually skips portions of the news program using a fast-forward function or a skip ahead function (e.g., skip ahead 30 seconds at a time) of the DVR. These are inadequate solutions for users, because a user is unable to automatically skip undesired portions of the news show or other types of content in an audio/video stream.

### BRIEF DESCRIPTION OF THE DRAWINGS

The same number represents the same element or same type of element in all drawings.

FIG. 1 illustrates an embodiment of a system for presenting content to a user.

FIG. 2 illustrates an embodiment of a graphical representation of a first audio/video stream received by a receiving device, and a second audio/video stream outputted by the receiving device.

FIG. 3 illustrates an embodiment in which the boundaries of a segment of an audio/video stream are identified based on a text string included in the text data associated with the audio/video stream.

FIG. 4 illustrates an embodiment of an audio/video stream.

FIG. 5 illustrates an embodiment of the audio/video stream of FIG. 4 partitioned into nine segments.

FIG. 6 illustrates an embodiment of a selection menu generated by the receiving device of FIG. 1.

FIG. 7 illustrates another embodiment of a selection menu generated by the receiving device of FIG. 1.

FIG. 8 illustrates an embodiment of a receiving device for presenting a recorded audio/video stream.

FIG. 9 illustrates an embodiment of a first audio/video stream of FIG. 8.

FIG. 10 illustrates an embodiment of a system in which multiple receiving devices are communicatively coupled to a communication network.

FIG. 11 illustrates an embodiment of a process for presenting a recorded audio/video stream.

FIG. 12 illustrates another embodiment of a process for presenting a recorded audio/video stream.

### DETAILED DESCRIPTION OF THE DRAWINGS

The various embodiments described herein generally provide apparatus, systems and methods which facilitate the reception, processing, and outputting of audio/video content. More particularly, the various embodiments described herein provide for the identification of multiple segments of content in a recorded audio/video stream. Thus, an audio/video stream may be segmented into various logical chapters, scenes or other sections and the like. The segments of the audio/video stream may then be selectably viewable by a user. In other words, a user may select which of the segments they desire to view, and a DVR may automatically present the selected segments, automatically skipping over the undesignated segments of the audio/video stream. In short, various embodiments described herein provide apparatus, systems and/or methods for partitioning an audio/video stream into a multiple segments for presentation to a user.

In at least one embodiment, the audio/video stream to be received, processed, outputted and/or communicated may come in any form of an audio/video stream. Exemplary audio/video stream formats include Motion Picture Experts Group (MPEG) standards, Flash, Windows Media and the like. It is to be appreciated that the audio/video stream may be supplied by any source, such as an over-the-air broadcast, a satellite or cable television distribution system, a digital video disk (DVD) or other optical disk, the internet or other communication networks, and the like. In at least one embodiment, the audio/video data may be associated with supplemental data that includes text data, such as closed captioning data or subtitles. Particular portions of the closed captioning data may be associated with specified portions of the audio/video data.

In various embodiments described herein, the text data associated with an audio/video stream is processed to identify portions of the audio/video stream. More particularly, the text data may be processed to identify boundaries of segments of the audio/video stream. The portions of the audio/video stream between identified boundaries may then be designated for presentation to a user, or may be designated for skipping during presentation of the audio/video stream. In at least one embodiment, the various segments designated for skipping and/or presentation may be determined based on user input. Thus, in at least one embodiment, portions of an audio/video stream that a user desires to view may be presented to the user, and portions of the audio/video stream that a user desires not to view may be skipped during presentation of the audio/video stream.

Generally, an audio/video stream is a contiguous block of associated audio and video data that may be transmitted to, and received by, an electronic device, such as a terrestrial (“over-the-air”) television receiver, a cable television receiver, a satellite television receiver, an internet connected television or television receiver, a computer, a portable electronic device, or the like. In at least one embodiment, an audio/video stream may include a recording of a contiguous block of programming from a television channel (e.g., an episode of a television show). For example, a digital video recorder may record a single channel between 7:00 and 8:00, which may correspond with a single episode of a television program. The television program may be comprised of multiple segments of video frames. For example, in a news broadcast, each distinct story may be considered a unique segment of the television program.

In at least one embodiment, a user may be presented with a menu of available segments of the television program, and may select one or more of the available segments for presentation. The recording device responsively outputs the selected segments, skipping presentation of the undesignated segments. For example, a user may select particular news stories that they desire to view, and the recording device may output the selected news stories back-to-back, skipping presentation of undesignated segments interspersed therebetween.

As described above, a user may effectively view a subset of the segments of an audio/video stream in the original temporal order of the segments, skipping output of undesignated segments of the audio/video steam. In some embodiments, a user may designate a different presentation order for the segments of the audio/video stream than the original presentation order of the segments. This allows the user to reorder the content of the recorded audio/video stream. For example, a recorded audio/video stream of a news broadcast may include “top stories”, “national news”, “local news”, “weather” and “sports” portions presented in that particular order. However, the user may desire to playback the recorded news broadcast in the following order: “sports”, “weather”, “top stories”, “local news” and “national news”. In at least one embodiment, a receiving device (e.g., a DVR) processes the recorded audio/video stream to determine the boundaries of each segment of the news broadcast. The user designates the playback order, and the DVR presents the various segments of the audio/video stream automatically in the designated order.

In some embodiments, a user may be restricted from temporally moving through particular segments of the audio/video stream at a non-real time presentation rate of the audio/video stream. In other words, a DVR may automatically output particular segments of the audio/video stream without skipping over or otherwise fast forwarding through the segments, regardless of whether a user provides input requesting fast forwarding or skipping through the segment. For example, commercials within a television program may be associated with restrictions against fast forwarding or skipping, and a recording device may automatically present the commercial segments regardless of the receipt of user input requesting non-presentation of the segments.

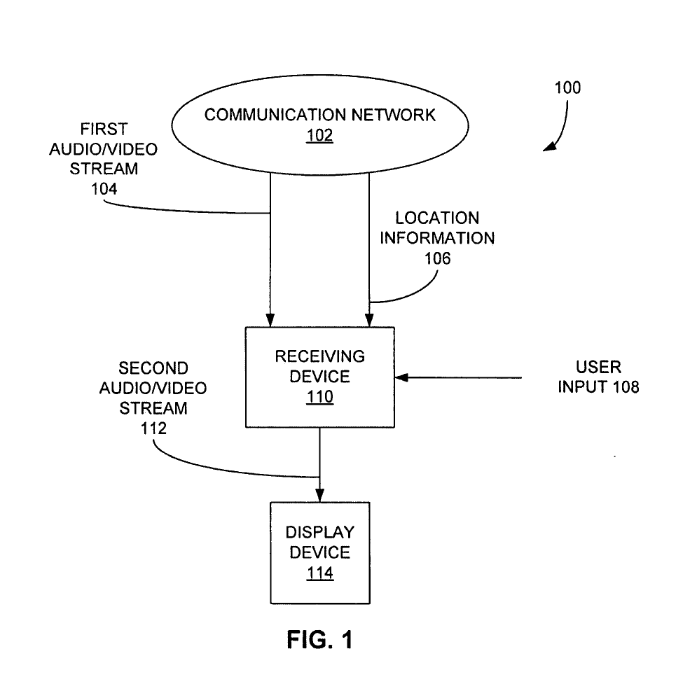

FIG. 1 illustrates an embodiment of a system 100 for presenting content to a user. The system of FIG. 1 is operable for partitioning audio/video content within a contiguous block of audio/video data into multiple segments which are selectable for presentation by the user. The system 100 includes a communication network 102, a receiving device 110 and a display device 114. Each of these components is discussed in greater detail below.

The communication network 102 may be any communication network capable of transmitting an audio/video stream. Exemplary communication networks include television distribution networks (e.g., over-the-air, satellite, cable and terrestrial television networks), wireless communication networks, public switched telephone networks (PSTN), and local area networks (LAN) or wide area networks (WAN) providing data communication services. An audio/video stream may be delivered by any transmission method, such as broadcast or point-to-point (by “streaming”, multicast, simulcast, closed circuit, pay-per-view, video-on-demand, file transfer, or other means), or other methods. The communication network 102 may utilize any desired combination of wired (e.g., cable and fiber) and/or wireless (e.g., cellular, satellite, microwave, and other types of radio frequency) communication mediums and any desired network topology (or topologies when multiple mediums are utilized).

The receiving device 110 of FIG. 1 may be any device capable of receiving an audio/video stream from the communication network 102. For example, in the case of the communication network 102 being a cable or satellite television network, the receiving device 110 may be a set-top box configured to communicate with the communication network 102. In at least one embodiment, the receiving device 110 may be a digital video recorder. In another example, the receiving device 110 may be computer, a personal digital assistant (PDA), or similar device configured to communicate with the internet or comparable communication network 102. While the receiving device 110 is illustrated as receiving content via the communication network 102, in other embodiments, the receiving device may receive, capture and/or record video streams from non-broadcast services, such as video recorders, DVD disks or DVD players, personal computers, external storage devices or the internet.

The display device 114 may be any device configured to receive an audio/video stream from the receiving device 110 and present the audio/video stream to a user. Examples of the display device 114 include a television, a video monitor, or similar device capable of presenting audio and video information to a user. The receiving device 110 may be communicatively coupled to the display device 114 through any type of wired or wireless connection. Exemplary wired connections include coax, fiber, composite video and high-definition multimedia interface (HDMI). Exemplary wireless connections include WiFi, ultra-wide band (UWB) and Bluetooth. In some implementations, the display device 114 may be integrated within the receiving device. 110. For example, each of a computer, a PDA, and a mobile communication device may serve as both the receiving device 110 and the display device 114 by providing the capability of receiving audio/video streams from the communication network 102 and presenting the received audio/video streams to a user. In another implementation, a cable-ready television may include a converter device for receiving audio/video streams from the communication network 102 and displaying the audio/video streams to a user.

In the system 100, the communication network 102 transmits a first audio/video stream 104 and location information 106 to the receiving device 110. The first audio/video stream 104 includes audio data and video data. In one embodiment, the video data includes a series of digital frames, or single images to be presented in a serial fashion to a user. Similarly, the audio data may be composed of a series of audio samples to be presented simultaneously with the video data to the user. In one, example, the audio data and the video data may be formatted according to one of the MPEG encoding standards, such as MPEG-2 or MPEG-4, as may be used in DBS systems, terrestrial Advanced Television Systems Committee (ATSC) systems or cable systems. However, different audio and video data formats may be utilized in other implementations.

Also associated with the first audio/video stream 104 is supplemental data providing information relevant to the audio data and/or the video data of the first audio/video stream 104. In one implementation, the supplemental data includes text data, such as closed captioning data or subtitles, available for visual presentation to a user during the presentation of the associated audio and video data of the first audio/video stream 104. In some embodiments, the text data may be embedded within the first audio/video stream 104 during transmission across the communication network 102 to the receiving device 110. In one example, the text data may conform to any text data or closed captioning standard, such as the Electronic Industries Alliance 708 (EIA-708) standard employed in ATSC transmissions or the EIA-608 standard. When the text data is available to the display device 114, the user may configure the display device 114 to present the text data to the user in conjunction with the video data.

Each of a number of portions of the text data may be associated with a corresponding portion of the audio data or video data also included in the first audio/video stream 104. For example, one or more frames of the video data of the first audio/video stream 104 may be specifically identified with a segment of the text data included in the first audio/video stream 104. A segment of text data may include displayable portions of the text data as well as non-displayable portions of the text data (e.g., codes utilized for positioning the text data). As a result, multiple temporal locations within the first audio/video stream 104 may be identified by way of an associated portion of the text data. For example, a particular text string or phrase within the text data may be associated with one or more specific frames of the video data within the first audio/video stream 104 so that the text string is presented to the user simultaneously with its associated video data frames. Therefore, the particular text string or phrase may provide an indication of a location of these video frames, as well as the portion of the audio data synchronized or associated with the frames.

The communication network 102 also transmits location information 106 to the receiving device 110. Further, the location information 106 may be transmitted to the receiving device 110 together or separately from the first audio/video stream 104. The location information 106 specifies locations within the first audio/video stream 104 that are utilized to identify the boundaries of the segments of the first audio/video stream 104. The boundaries may then be utilized to identify the segments that are to be skipped and/or presented during presentation of the audio/video data of the first audio/video stream 104 by the receiving device 110. The location information 106 references the text data to identify a video location within the first audio/video stream 104. The video location may then be utilized to determine the boundaries of segments of the first audio/video stream 104. In at least one embodiment, the location information 106 identifies a reference frame and includes at least one offset that points to a boundary within of a segment of the first audio/video stream 104. For example, a reference frame may be associated with beginning and ending offsets that point to beginning and ending boundaries, respectively, of a segment of the first audio/video stream 104.

In at least one embodiment, the receiving device 110 receives user input 108 designating particular segments of the first audio/video stream 104 for presentation to a user. The user input 108 may designate all of the segments of the first audio/video stream 104, or a subset of the segments of the first audio/video stream 104. The subset of the segments of the video stream to be presented may be contiguous or non-contiguous. In at least one embodiment, the user input 108 is received responsive to a menu of available segments of the first audio/video stream 104 outputted by the receiving device 110. For example, the receiving device 110 may present a menu indicating each of the segments of the first audio/video stream 104 along with descriptions of the segments. In at least one embodiment, the menu is generated based on information included in the location information 106. Based on the user input 108, the receiving device 110 identifies segments of the audio/video content of the first audio/video stream 104 which are to be presented and/or skipped during presentation, and the receiving device 110 outputs a second audio/video stream 112 including the segments designated for presentation.

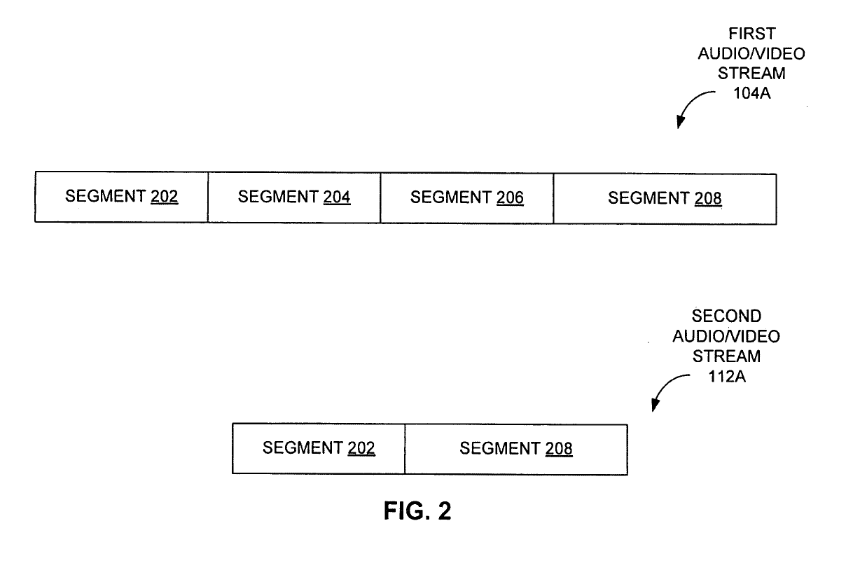

FIG. 2 illustrates an embodiment of a graphical representation of a first audio/video stream 104A received by the receiving device 110, and a second audio/video stream 112A outputted by the receiving device 110. FIG. 2 will be discussed in reference to the system 100 of FIG. 1.

The first audio/video stream 104A includes a first audio/video segment 202, a second audio/video segment 204, a third audio/video segment 206 and a fourth audio/video segment 208. Each of the segments 202-208 is a logical or chapter grouping of content within the first audio/video stream 104A. When recorded, the first audio/video stream 104A is not physically or logically partitioned into the segments 202-208. In other words, the receiving device 110 may not know the beginning and ending boundaries of each logical segment 202-208. The receiving device 110 receives and utilizes the location information 106 to identify the boundaries of the segments 202-208. The boundaries of the segments 202-208 may be utilized to output and/or skip selected segments during presentation of the segments 202-208.

In the specific example of FIG. 2, the receiving device 110 receives user input 108 requesting presentation of the segments 202 and 208. Similarly, the user input 108 indicates that the segments 204 and 206 should be skipped during presentation of the first audio/video stream 104A. The receiving device 110 outputs a second audio/video stream 112A responsive to the user input 108, with the second audio/video stream 112A including the first audio/video segment 202 followed by the fourth audio/video segment 208. As a result, the receiving device 110 skips presentation of the segments 204-206 which were not designated for presentation by the user input 108.

As described above, the receiving device 110 may identify the boundaries of the segments 202-208 of the first audio/video stream 104A by processing the text data associated with the first audio/video stream 104A. The boundaries of the segments 202-208 are identified based on one or more video locations within the first audio/video stream 104A. More particularly, the beginning and ending boundaries of a particular segment 202-208 of the first audio/video stream 104A may be specified by a single video location within the segment. Thus, each segment may be identified by a video location within the first audio/video stream 104A.

To specify a video location within the first audio/video stream 104A, the location information 106 references a portion of the text data associated with the first audio/video stream 104A. A video location within the first audio/video stream 104A may be identified by a substantially unique text string or other data segment within the text data that may be unambiguously detected by the receiving device 110. The text data may consist of a single character, several characters, an entire word, multiple consecutive words, or the like. In at least one embodiment, the text data may comprise closed captioning formatting commands or other type of data included within a closed captioning string. Thus, the receiving device 110 may review the text data to identify the location of the unique text string. Because the text string in the text data is associated with a particular location within the first audio/video stream 104A, the location of the text string may be referenced to locate the video location within the first audio/video location.

In some embodiments, multiple video locations may be utilized to specify the beginning and ending boundaries of a segment. In at least one embodiment, a single video location is utilized to identify the beginning and ending boundaries of a segment. The video location may be located at any point within the segment, and offsets may be utilized to specify the beginning and ending boundaries of the segment relative to the video location. In one implementation, a human operator, of a content provider of the first audio/video stream 104A, bears responsibility for selecting the text string, the video location and/or the offsets. In other examples, the text string, video location and offset selection occurs automatically under computer control, or by way of human-computer interaction. A node within the communication network 102 may then transmit the selected text string to the receiving device 110 as the location information 106, along with the forward and backward offset data.

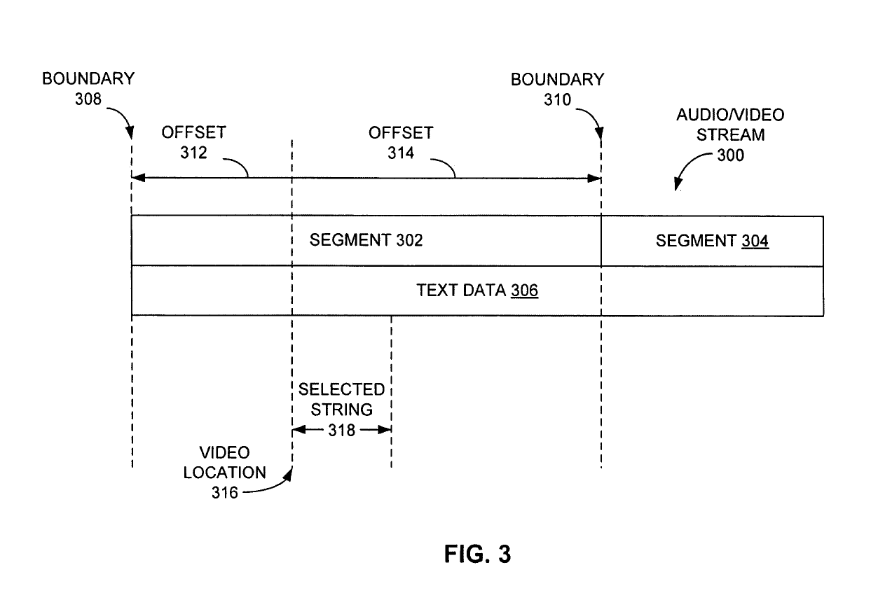

FIG. 3 illustrates an embodiment in which the boundaries of a segment of an audio/video stream 300 are identified based on a text string included in the text data associated with the audio/video stream 300. FIG. 3 will be discussed in reference to system 100 of FIG. 1. The audio/video stream 300 includes a first audio/video segment 302, a second audio/video segment 304 and text data 306. The first audio/video segment 302 is defined by a boundary 308 and a boundary 310. The location information 106 received by the receiving device 110 identifies the first audio/video segment 302 using a selected string 318 and offsets 312 and 314. Each of these components is discussed in greater detail below.

The receiving device 110 reviews the text data 306 to locate the selected string 318. As illustrated in FIG. 3, the selected string 318 is located at the video location 316. More particularly, in at least one embodiment, the beginning of the selected string 318 corresponds with the frame located at the video location 316. After locating the video location 316, the receiving device 110 utilizes the negative offset 312 to identify the beginning boundary 308. Likewise, the receiving device 110 utilizes the positive offset 314 to identify the ending boundary 31Q. The offsets 312 and 314 are specified relative to the video location 316 to provide independence from the absolute presentation times of the video frames associated with the boundaries 308 and 310 within the audio/video stream 300. For example, two users may begin recording a particular program from two different affiliates (e.g., one channel in New York City and another channel in Atlanta). Thus, the absolute presentation time of the boundaries 308 and 310 will vary within the recordings. The technique described herein locates the same video frames associated with the boundaries 308 and 310 regardless of their absolute presentation times within a recording.

A similar process may be used with similar data to identify boundaries of other segments of the audio/video stream 300, such as the segment 304. By locating the boundaries of each of the segments 302-304 of the audio/video stream 300, the receiving device 110 may determine which segments 302-304 to output for presentation responsive to the user input 108. For example, the receiving device 110 may present a menu of the identified segments 302-304 and allow a user to select which segments 302-304 should be presented.

Take for example the situation in which the receiving device 110 records a sports news broadcast for later presentation to a user. The sports news broadcast may include several distinct stories which are logically grouped together by sport or by other characteristics. For example, the sports news broadcast may begin with coverage of basketball playoff games, followed by coverage of the football draft, coverage of baseball games and coverage of hockey playoff games. A user may desire to watch specific stories regarding their favorite teams or athletes, while skipping over the stories of no interest to the user.

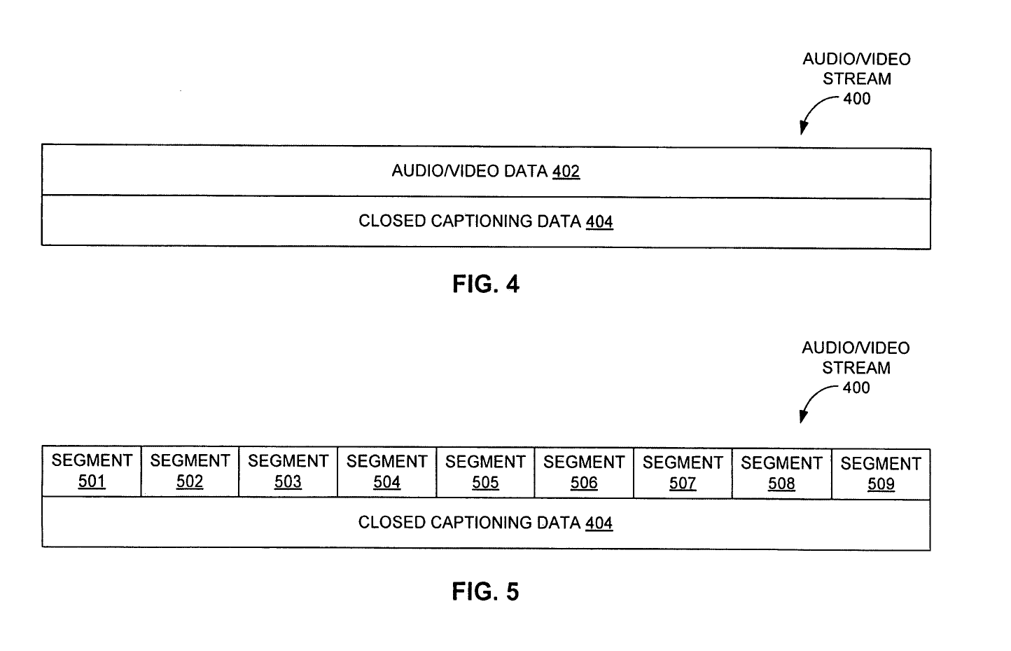

FIG. 4 illustrates an embodiment of an audio/video stream 400. More particularly, the audio/video stream 400 comprises audio/video content of a sports news broadcast. The audio/video stream 400 will be discussed in reference to the system 100 of FIG. 1. The receiving device 110 initially records the audio/video stream 400 of the sports news broadcast. The audio/video stream 400 includes a one hour contiguous block of audio/video data 402 and associated closed captioning data 404. The audio/video data 402 does not include information identifying the beginning and ending locations of the various stories of the sports news broadcast. In other words, the audio/video data 402 does not include segment markers for each story segment of the sports news broadcast. In the described embodiment, the sports news broadcast includes nine stories, which are originally ordered in the sports news broadcast as illustrated below in Table 1. For the sake of simplicity, the audio/video stream 400 is illustrated without advertising content (e.g., commercials) interspersed within the segments of the sports news broadcast. However, it is to be appreciated that in some embodiments commercial breaks may be include and may comprise additional segments of an audio/video stream.

TABLE 1
Order of stories within a sports news broadcast
BASKETBALL PLAYOFF GAME STORIES

| | |
|---|---|
| 1) | Los Angeles vs. Denver |
| 2) | Dallas vs. San Antonio |
| 3) | Cleveland vs. Boston |

FOOTBALL DRAFT STORIES

| | |
|---|---|
| 4) | Top college QB to enter draft |

BASEBALL GAME STORIES

| | |
|---|---|
| 5) | New York vs. Boston |
| 6) | Tampa Bay vs. Los Angeles |
| 7) | Colorado vs. Chicago |

HOCKEY PLAYOFF GAME STORIES

| | |
|---|---|
| 8) | Colorado vs. Detroit |
| 9) | Montreal vs. Toronto |

The receiving device 110 receives the location information 106, which indicates that there are a total of nine segments within the sports news broadcast. The location information 106 includes nine sets of segment identifying information, each set utilized to identify a particular segment of the audio/video stream 400. Each set of identifying information in the location information 106 includes a data segment, included within the closed captioning data of the audio/video data 402, that is associated with a particular video location of the audio/video data 402. For example, each data segment may comprise a unique word or phrase located within the closed captioning data of the audio/video data. In some embodiments, each data segment may also be associated with one or more offsets that point to boundaries of a segment of the audio/video stream 400.

The receiving device 110 utilizes the location information 106 to partition the audio/video data 402 into multiple segments. As illustrated in FIG. 5, the audio/video stream 400 may be partitioned into nine segments 501-509 of audio/video data, which are identified by the receiving device 110 as described in detail above. The location information 106 further includes information utilized to generate a selection menu including the segments 501-509.

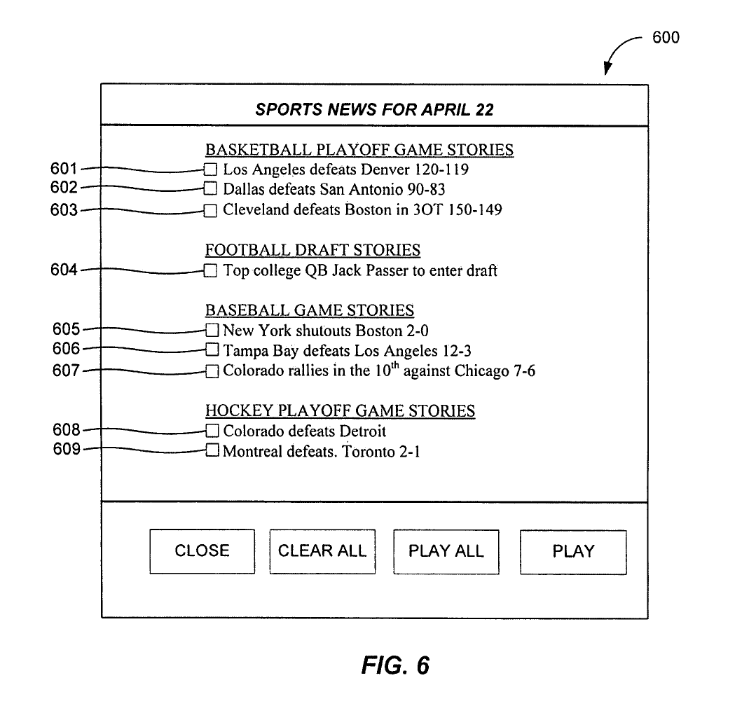

FIG. 6 illustrates an embodiment of a selection menu 600 generated by the receiving device 110 of FIG. 1. The selection menu 600 includes a plurality of checkboxes 601-609, each associated with a particular segment 501-509 of the audio/video stream. Each checkbox 601-609 is also associated with a description of the associated segment 501-509. The description, as well as the layout of the menu 600, may be provided in the location information 106.

A user selects one or more of the checkboxes 601-609 to indicate the particular segments 501-509 that they desire to view. For example, a user in Denver may activate checkboxes 601, 607 and 608, indicating that they desire to view the stories involving their local sports teams. Responsive to the user selections, the receiving device 110 outputs an audio/video stream that includes segments 501, 507 and 509, while not outputting segments 502, 503, 504, 505, 506 and 509. Thus, the user is able view the content that they desire and automatically skip over the content of no interest to the user.

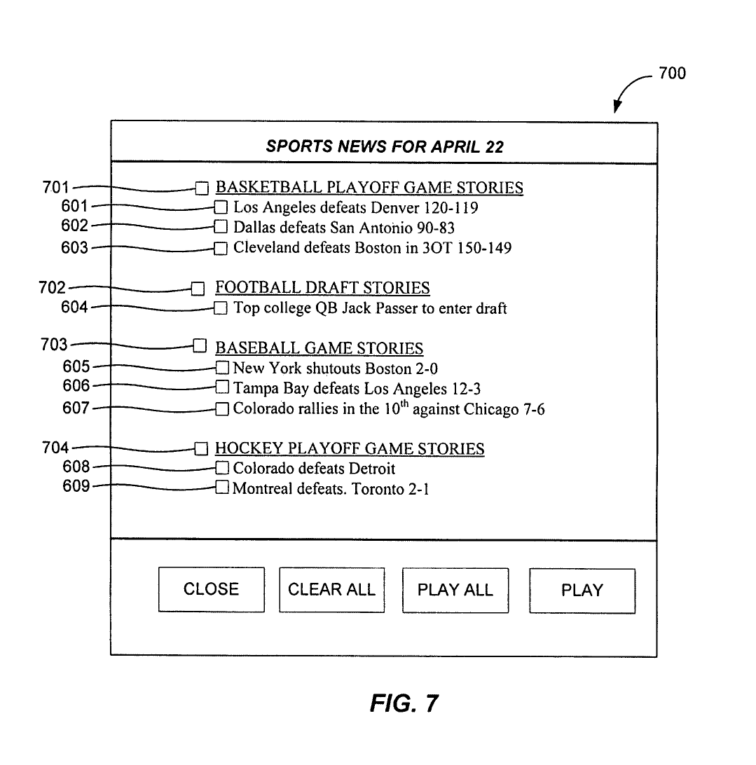

In at least one embodiment, the receiving device 110 may allow a user to select segments of an audio/video stream for viewing through a hierarchical menu structure. FIG. 7 illustrates another embodiment of a selection menu 700 generated by the receiving device 110 of FIG. 1. More particularly, the selection menu 700 presents a hierarchical structure of checkboxes for selection by a user. In addition to the checkboxes 601-609 of FIG. 6, the selection menu 700 includes checkboxes 701-704, each corresponding to a particular group of checkboxes 601-609. For example, checkbox 701 allows a user to select for viewing all of the basketball playoff game segments of the sports news broadcast. In effect, the activation of the checkbox 701 activates the checkboxes 601-603. Thus, the selection menu 700 allows a user to select a subset of associated contiguous segments 501-509 (see FIG. 1) for presentation, and additionally allows the user to select other non-contiguous individual segments 501-509 (see FIG. 1). For example, a user may activate checkboxes 601, 703 and 608 and press the “PLAY” button. In response to the selections, the receiving device 110 outputs segments 501, 505, 506, 507 and 508 for presentation to the user, skipping over the undesignated segments of the audio/video stream 400.

It is to be appreciated that any number of hierarchical levels or organization of segments may be employed depending on desired design criteria. For example, a recorded baseball game may be segmented by inning, by half inning, by at bat, by pitch or any combination thereof. Thus, a user may navigate a menu to indicate which portions of the baseball game they desire to view. For example, a user may select to view the offensive half innings of their favorite team (e.g., when their favorite team is at-bat). In another scenario, a user may select to view the at-bats of their favorite player. In still another scenario, a user may wish to view particular pitches of the game, such as the pitches upon which players got base hits. Thus, the user avoids watching other portions of the game that include very little action.

In at least one embodiment, the location information 106 is provided by a service provider, such as a satellite television or cable television distributor. The service provider may determine the appropriate granularity for the segmentation of an audio/video stream based on various criteria, such as the content of the audio/video stream, the length of the audio/video stream, the logical break points of the content and the like.

In at least one embodiment, the selection menu 700 may include user input fields that allow a user to indicate the desired presentation order of the segments 501-509 of the audio/video stream 400. For example, the user may indicate that segment 508 should be presented first, followed by segments 505-507 and commencing with segment 501. Thus, the receiving device adjusts the presentation order of the selected segments of the audio/video stream 400 during presentation.

Returning to FIG. 3, depending on the resiliency and other characteristics of the text data, the node of the communication network 102 generating and transmitting the location information 106 may issue more than one instance of the location information 106 to the receiving device 110. For example, text data, such as closed captioning data, is often error-prone due to transmission errors and the like. As a result, the receiving device 110 may not be able to detect some of the text data, including the text data selected to specify the video location 316. To address this issue, multiple unique text strings may be selected from the text data 306 of the audio/video stream 300 to indicate multiple video locations (e.g., multiple video locations 316), each having a different location in the audio/video stream 300. Each string has differing offsets relative to the associated video location that point to the same boundaries 308 and 310. The use of multiple text strings (each accompanied with its own offset(s)) may thus result in multiple sets of location information 106 transmitted over the communication network 102 to the receiving device 110, each of which is associated with the first audio/video segment 302. Each set of location information 106 may be issued separately, or may be transmitted in one more other sets.

The location information 106 may be associated with the first audio/video stream 104 to prevent any incorrect association of the data with another audio/video stream. Thus, an identifier may be included with the first audio/video stream 104 to relate the first audio/video stream 104 and the location information 106. In one particular example, the identifier may be a unique program identifier (UPID). Each show may be identified by a UPID. A recording (e.g., one file recorded by a receiving device between 7:00 and 8:00) may include multiple UPIDs. For example, if a television program doesn't start exactly at the hour, then the digital video recorder may capture a portion of a program having a different UPID. The UPID allows a digital video recorder to associate a particular show with its corresponding location information 106.

Use of an identifier in this context addresses situations in which the location information 106 is transmitted after the first audio/video stream 104 has been transmitted over the communication network 102 to the receiving device 110. In another scenario, the location information 106 may be available for transmission before the time the first audio/video stream 104 is transmitted. In this case, the communication network 102 may transmit the location information 106 before the first audio/video stream 104.

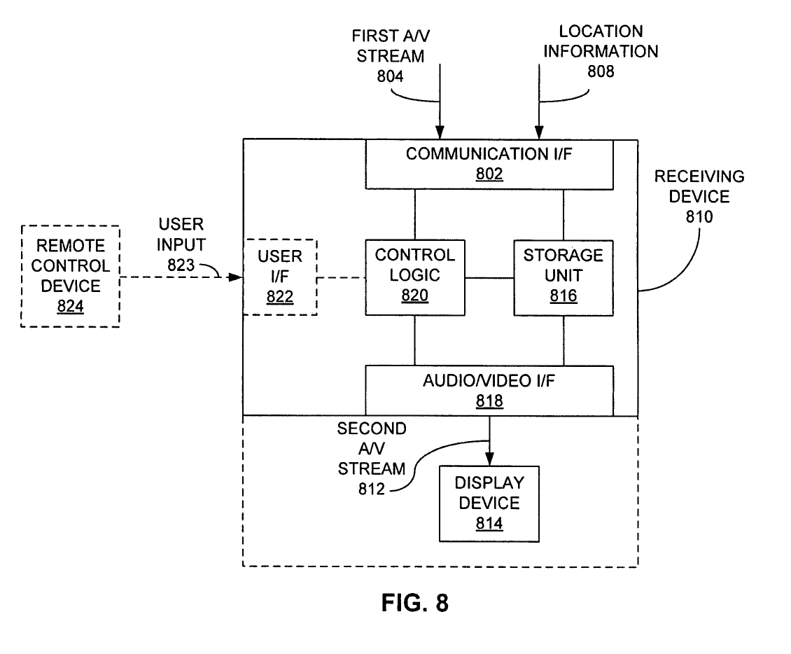

A more explicit view of a receiving device 810 according to one embodiment is illustrated in FIG. 8. The receiving device 810 includes a communication interface 802, a storage unit 816, an audio/video interface 818 and control logic 820. In some implementations, a user interface 822 may also be employed in the receiving device 810. Other components possibly included in the receiving device 810, such as demodulation circuitry, decoding logic, and the like, are not shown explicitly in FIG. 8 to facilitate brevity of the discussion.

The communication interface 802 may include circuitry to receive a first audio/video stream 804 and location information 808. For example, if the receiving device 810 is a satellite set-top box, the communication interface 802 may be configured to receive satellite programming, such as the first audio/video stream 804, via an antenna from a satellite transponder. If instead, the receiving device 810 is a cable set-top box, the communication interface 802 may be operable to receive cable television signals and the like over a coaxial cable. In either case, the communication interface 802 may receive the location information 808 by employing the same technology used to receive the first audio/video stream 804. In another implementation, the communication interface 802 may receive the location information 808 by way of another communication technology, such as the internet, a standard telephone network, or other means. Thus, the communication interface 802 may employ one or more different communication technologies, including wired and wireless communication technologies, to communicate with a communication network, such as the communication network 102 of FIG. 1.

Coupled to the communication interface 802 is a storage unit 816, which is configured to store both the first audio/video stream 804 and the location information 808. The storage unit 816 may include any storage component configured to store one or more such audio/video streams. Examples include, but are not limited to, a hard disk drive, an optical disk drive and flash semiconductor memory. Further, the storage unit 816 may include either or both volatile and nonvolatile memory.

Communicatively coupled with the storage unit 816 is an audio/video interface 818, which is configured to output audio/video streams from the receiving device 810 to a display device 814 for presentation to a user. The audio/video interface 818 may incorporate circuitry to output the audio/video streams in any format recognizable by the display device 814, including composite video, component audio, the Digital Visual Interface (DVI), the High-Definition Multimedia Interface (HDMI), Digital Living Network Alliance (DLNA), Ethernet, Multimedia over Coax Alliance (MOCA), WiFi and IEEE 1394. Data may be compressed and/or transcoded for output to the display device 814. The audio/video interface 818 may also incorporate circuitry to support multiple types of these or other audio/video formats. In one example, the display device 814, such as a television monitor or similar display component, may be incorporated within the receiving device 810, as indicated earlier.

In communication with the communication interface 802, the storage unit 816, and the audio/video interface 818 is control logic 820 configured to control the operation of each of these three components 802, 816, 818. In one implementation, the control logic 820 includes a processor, such as a microprocessor, microcontroller, digital signal processor (DSP), or the like for execution of software configured to perform the various control functions described herein. In another embodiment, the control logic 820 may include hardware logic circuitry in lieu of, or in addition to, a processor and related software to allow the control logic 820 to control the other components of the receiving device 810.

Optionally, the control logic 820 may communicate with a user interface 822 configured to receive user input 823 directing the operation of the receiving device 810. The user input 823 may be generated by way of a remote control device 824, which may transmit the user input 823 to the user interface 822 by the use of, for example, infrared (IR) or radio frequency (RF) signals. In another embodiment, the user input 823 may be received more directly by the user interface 822 by way of a touchpad or other manual interface incorporated into the receiving device 810.

The receiving device 810, by way of the control logic 820, is configured to receive the first audio/video stream 804 by way of the communication interface 802, and store the audio/video stream 804 in the storage unit 816. The location information 808 is also received at the communication interface 802, which may pass the location information 808 to the control logic 820 for processing. In another embodiment, the location information 808 may be stored in the storage unit 816 for subsequent retrieval and processing by the control logic 820.

At some point after the location information 808 is processed, the control logic 820 generates and transmits a second audio/video stream 812 over the audio/video interface 818 to the display device 814. In one embodiment, the control logic 820 generates and transmits the second audio/video stream 812 in response to the user input 823. For example, the user input 823 may command the receiving device 810 to output particular portions of the first audio/video stream 804 to the display device 814 for presentation. In another embodiment, the user input 823 may request presentation of particular portions of the first audio/video stream 804 in a different order than the original intended presentation order of the first audio/video stream 804. In response, the control logic 820 generates and outputs the second audio/video stream 812. Like the second audio/video stream 112 described above in FIG. 1, the second audio/video stream 812 includes selected segments of the audio/video data of the first audio/video stream 804 designated by the user input 823, but does not include undesignated segments of the first audio/video stream 604.

Depending on the implementation, the second audio/video stream 812 may or may not be stored as a separate data structure in the storage unit 816. In one example, the control logic 820 generates and stores the entire second audio/video stream 812 in the storage unit 816. The control logic 820 may further overwrite the first audio/video stream 804 with the second audio/video stream 812 to save storage space within the storage unit 816. Otherwise, both the first audio/video stream 804 and the second audio/video stream 812 may reside within the storage unit 816.

In another implementation, the second audio/video stream 812 may not be stored separately within the storage unit 816. For example, the control logic 820 may instead generate the second audio/video stream 812 “on the fly” by transferring selected portions of the audio data and the video data of the first audio/video stream 804 in a selected presentation order from the storage unit 816 to the audio/video interface 818.

In one implementation, a user may select by way of the user input 823 whether the first audio/video stream 804 or the second audio/video stream 812 is outputted to the display device 814 by way of the audio/video interface 818. In another embodiment, a content provider of the first audio/video stream 804 may prevent the user from maintaining such control by way of additional information delivered to the receiving device 810.

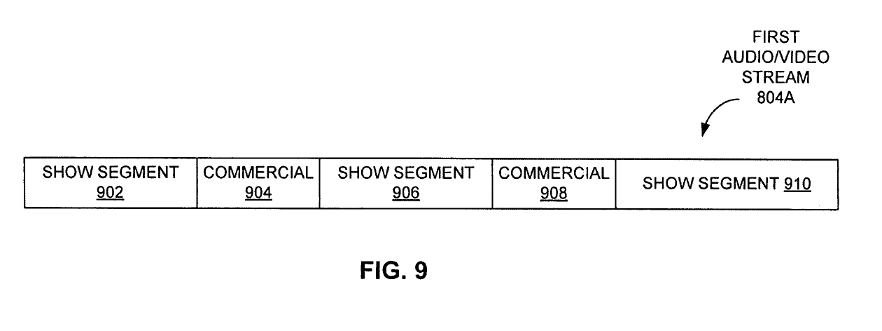

In one embodiment, the location information 808 may indicate that particular segments of the first audio/video stream 804 are to be presented, regardless of the user input 823. For example, the first audio/video stream 604 may include three portions of a television show interspersed with two commercial breaks. FIG. 9 illustrates an embodiment of a first audio/video stream 804A of FIG. 8. The first audio/video stream 804A includes a first show segment 902, a first commercial segment 904, a second show segment 906, a second commercial segment 908 and a third show segment 910.

The control logic 820 receives the location information 808, and identifies the locations of each of the segments 902-910. The control logic 820 further identifies restrictions imposed upon the commercial segments 904 and 908. For example, a user may be unable to provide user input 823 requesting to skip through or fast forward through the commercial segments 904 and 908. Thus, if the output interface 818 is presently outputting the commercial segment 904, then the control logic 820 may command the output interface 818 to continue presenting the commercial segment 904 even if user input 823 is received that requests to skip ahead to the show segment 906 or to fast-forward through the commercial segment 904. Once the output interface 818 has outputted the video frame associated with the ending boundary of the commercial segment 904, then the control logic 820 may remove the restriction such that a user may fast forward or otherwise skip over the show segment 906.

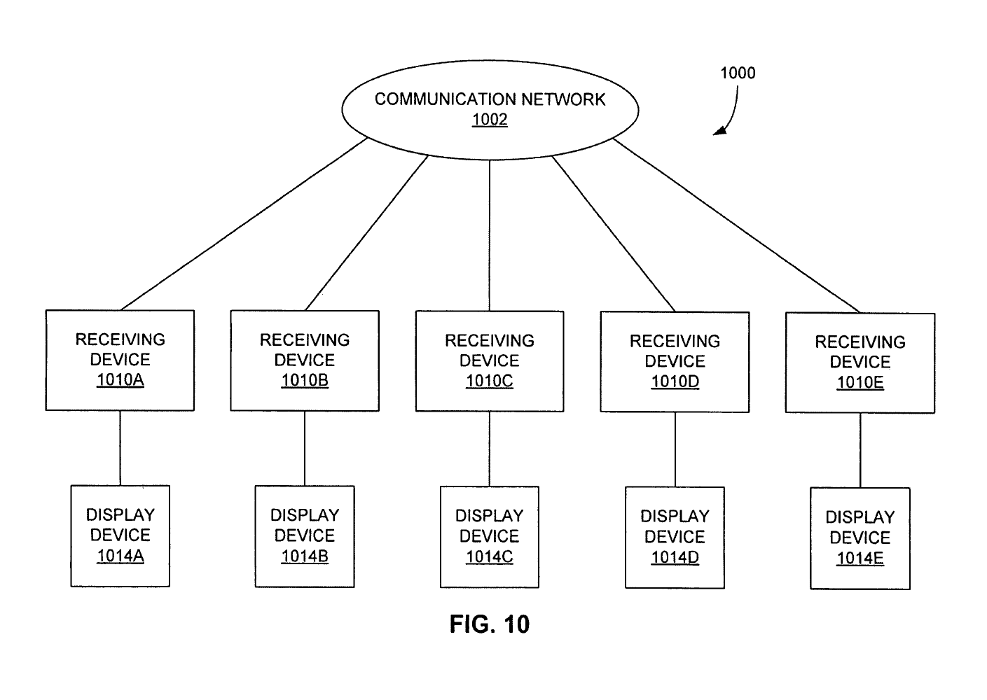

In a broadcast environment, such as that depicted in the system 1000 of FIG. 10, multiple receiving devices 1010A-E may be coupled to a communication network 1002 to receive audio/video streams, any of which may be recorded, in whole or in part, by any of the receiving devices 1010A-E. In conjunction with any number of these audio/video streams, the location information used for identifying segments of the audio/video stream may be transferred to the multiple receiving devices 1010A-E. In response to receiving the audio/video streams, each of the receiving devices 1010A-E may record any number of the audio/video streams received. For any location information that is transmitted over the communication network 1002, each receiving device 1010A-E may then review whether the received location information is associated with an audio/video stream currently stored in the device 1010A-E. If the associated stream is not stored therein, then the receiving device 1010A-E may delete or ignore the location information received. In some embodiments, the receiving device 1010A may store the location information for possible later use. For example, the receiving device 1010A may receive location information for a program that has yet to be broadcast to the receiving device 1010A.

In another embodiment, instead of broadcasting each possible set of location information, the transfer of an audio/video stream stored within the receiving device 1010A-E to an associated display device 1014A-E may cause the receiving device 1010A-E to query the communication network 1002 for any outstanding location information that apply to the stream to be presented. For example, the communication network 1002 may comprise an internet connection. As a result, the broadcasting of each set of location information is not required, thus potentially reducing the amount of consumed bandwidth over the communication network 1002.

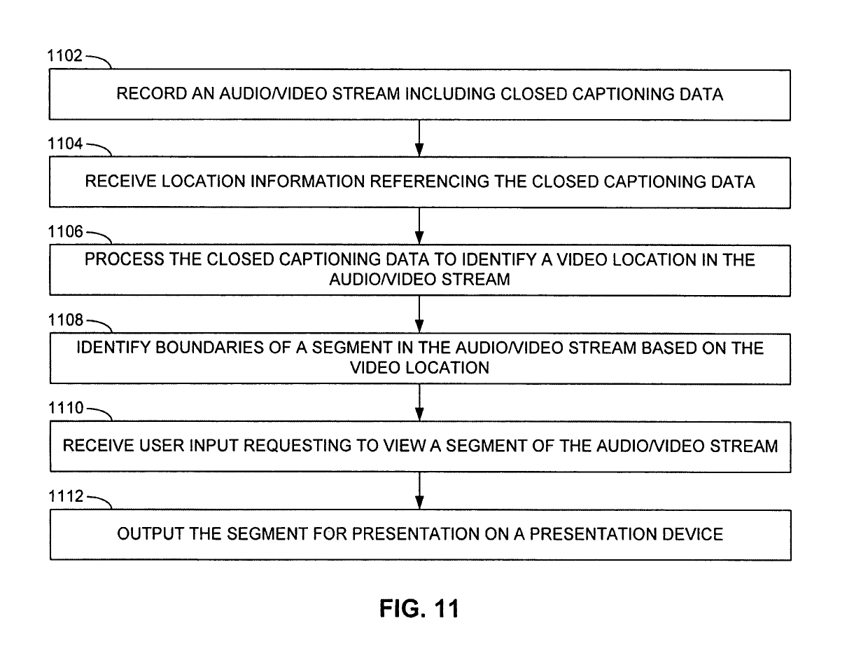

FIG. 11 illustrates an embodiment of a process for presenting a recorded audio/video stream. More particularly, the process of FIG. 11 allows a recording device to segment a recorded audio/video stream and allow a user to selectably view particular segments of the recorded audio/video stream. The operation of FIG. 11 is discussed in reference to presenting a broadcast television program. However, it is to be appreciated that the operation of the process of FIG. 11 may be applied to segment and present other types of video stream content. The operations of the process of FIG. 11 are not all-inclusive, and may comprise other operations not illustrated for the sake of brevity.

The process includes recording an audio/video stream including closed captioning data (operation 1102). Closed captioning data is typically transmitted in two or four byte intervals associated with particular video frames. Because video frames don't always arrive in their presentation order, the closed captioning data may be sorted according to the presentation order (e.g., by a presentation time stamp) of the closed captioning data. In at least one embodiment, the sorted closed captioning data may then be stored in a data file separate from the audio/video stream.

The process further includes receiving autonomous location information associated with the audio/video stream (operation 1104). The location information references the closed captioning data to identify a video location within the audio/video stream. The location information may be utilized to identify particular segments of the audio/video stream. Operations 1102 and 1104 may be performed in parallel, sequentially or in either order. For example, the location information may be received prior to recording the audio/video stream, subsequently to recording the audio/video stream, or at the same time as the audio/video stream. In at least one embodiment, the location information is received separately from the audio/video stream.

As described above, closed captioning data may be sorted into a presentation order and stored in a separate data file. In at least one embodiment, the sorting process is performed responsive to receiving the location information in step 1104. Thus, a digital video recorder may not perform the sorting process on the closed captioning data unless the location information used to filter the audio/video stream is available for processing. In other embodiments, the closed captioning data may be sorted and stored before the location information arrives at the digital video recorder. For example, the sorting process may be performed in real-time during recording.

The process further includes processing the closed captioning data to identify one or more video locations in the audio/video stream (operation 1106). More particularly, a text string included within the closed captioning data may be utilized to identify a specific location within the audio/video stream (e.g., a video location). The text string may be a printable portion of the text data or may comprise formatting or display options, such as text placement information, text coloring information and the like.

The process further includes identifying boundaries of segments of the audio/video stream based on the video locations (operation 1108). More particularly, the boundaries of the segments are identified based on offsets relative to the video location. For example, the beginning boundary of a segment may be identified by a negative offset relative to a particular video location. Similarly, an ending boundary of a segment may be identified by a positive offset relative to a particular video location.

The process further includes receiving user input requesting to view at least one of the segments of the audio/video stream (operation 1110). In at least one embodiment, the user input may be solicited responsive to a menu or list as described above. Operation 1110 may optionally or alternatively include receiving user input selecting segments which are to be skipped. For example, a user may activate checkboxes in a menu indicating which segments they desire not to view.

The process further includes outputting the selected segments for presentation on a presentation device (operation 1112). Thus, unselected segments are skipped during the presentation, and the DVR effectively outputs a second audio/video stream.

The method of FIG. 11 may be utilized to segment and present various types of video content to a user. For example, a movie or television show may be segmented into chapters or scenes which are selectably viewable by a user, similar to a DVD chapter selection menu. As described above, news programs may be segmented by story or topic such that a user may select the stories they desire to view. A user may optionally or alternatively dictate the particular presentation order of the segments, reordering the news broadcast as desired. In another embodiment, recorded video content, such as a home improvement show, may be segmented into a how-to video with selectable chapters. Thus, a viewer may jump to the particular “lesson” that they desire to view.

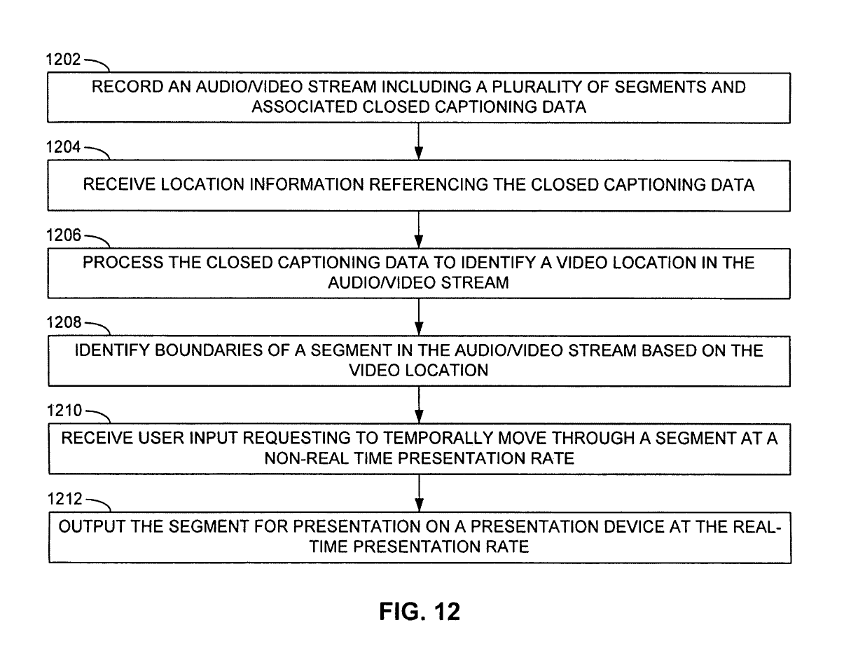

FIG. 12 illustrates another embodiment of a process for presenting a recorded audio/video stream. More particularly, the process of FIG. 12 allows a service provider or broadcaster to restrict a user from moving through particular segments of a recorded audio/video stream at a non-real time presentation rate of the audio/video stream. In other words, a user is restricted from fast forwarding or skipping over particular segments of the audio/video stream. The operation of FIG. 12 is discussed in reference to presenting a broadcast television program. However, it is to be appreciated that the operation of the process of FIG. 12 may be applied to segment and present other types of video stream content. The operations of the process of FIG. 12 are not all-inclusive, and may comprise other operations not illustrated for the sake of brevity.

The process includes recording an audio/video stream including a plurality of segments and associated closed captioning data (operation 1202). Operation 1202 may be performed similarly to operation 1102 described above.

The process further includes receiving autonomous location information referencing the closed captioning data of the audio/video stream (operation 1204). The location information references the closed captioning data to identify a video location within the audio/video stream, as described in operation 1104 of FIG. 11. The autonomous location information further identifies one or more segments of the audio/video stream that a user is restricted from temporally moving through at a non-real time presentation rate of the audio/video stream. Operations 1202 and 1204 may be performed in parallel, sequentially or in either order.

The process further includes processing the closed captioning data to identify one or more video locations in the audio/video stream (operation 1206). Operation 1206 may be performed similarly to operation 1106 of FIG. 11. The process further includes identifying boundaries of segments of the audio/video stream based on the video locations (operation 1208). Operation 1208 may be performed similarly to operation 1108 of FIG. 11.

The process further includes receiving user input requesting to temporally move through a segment of the audio/video stream at the non-real time presentation rate of the audio/video stream (operation 1210). More particularly, the user input requests to temporally move through the restricted segment of the audio/video stream. The user input may be provided through any appropriate means for requesting temporal movement through an audio/video segment. For example, a user may utilize a skip ahead button or fast forward button of a remote control to provide the user input. The receiving device identifies that the non-real time temporal movement though the segment is restricted, and responsively outputs the segment at the real-time presentation rate of the audio/video stream (operation 1212). Effectively, the user input is ignored, and the user is unable to command the receiving device to skip over or fast forward through the restricted segment.

Although specific embodiments were described herein, the scope of the invention is not limited to those specific embodiments. The scope of the invention is defined by the following claims and any equivalents therein.

What is claimed is:

1. A method for presenting a recorded audio/video stream, the method comprising:
recording an audio/video stream that includes associated closed captioning data;
receiving autonomous location information referencing the closed captioning data to identify at least one video location within the audio/video stream;
processing the closed captioning data to identify the at least one video location;
identifying boundaries of multiple segments of the audio/video stream based on the at least one video location;
receiving user input requesting to view at least one of the segments of the audio/video stream; and
outputting the at least one of the segments for presentation on a presentation device.

2. The method of claim 1, wherein receiving the autonomous location information further comprises:
receiving the autonomous location information separately from the audio/video stream.

3. The method of claim 1, further comprising:
sorting the closed captioning data according to a presentation order of the closed captioning data; and
storing the sorted closed captioning data in a data file separate from the audio/video stream;
wherein processing the closed captioning data comprises lexically analyzing the sorted closed captioning data in the data file to identify the at least one video location.

4. The method of claim 1, wherein receiving the autonomous location information further comprises:
receiving at least one data segment contained in the closed captioning data;
receiving a beginning offset, associated with the at least one data segment, that is relative to the video location, the beginning offset identifying a beginning location of the at least one of the segments of the audio/video stream; and
receiving an ending offset, associated with the at least one data segment, that is relative to the video location, the ending offset identifying an ending location of the at least one of the segments of the audio/video stream.

5. The method of claim 4, wherein the at least one data segment is unique within the at least one of the segments of the audio/video stream.

6. The method of claim 1, wherein receiving user input further comprises:
generating a selection menu of the segments of the audio/video stream; and
receiving a user selection of the at least one of the segments of the audio/video stream from the selection menu.

7. The method of claim 6, wherein generating the selection menu further comprises:
generating the selection menu based on data associated with the autonomous location information.

8. The method of claim 6, wherein the user selection designates a subset of the segments of the audio/video stream for presentation, and wherein outputting the at least one of the segments for presentation further comprises:
outputting the subset of the segments of the audio/video stream in an original temporal order, skipping output of undesignated segments of the audio/video stream.

9. The method of claim 6, wherein the user selection designates a subset of the segments of the audio/video stream for presentation and a user defined presentation order for the subset of the segments of the audio/video stream, and wherein outputting the at least one of the segments for presentation further comprises:
outputting the subset of the segments of the audio/video stream in the ser defined presentation order, skipping output of undesignated segments of the audio/video stream.

10. A method for presenting a recorded audio/video stream, the method comprising:
recording an audio/video stream including a plurality of segments and associated closed captioning data;
receiving autonomous location information referencing the closed captioning data to identify at least one video location within the audio/video stream, the video location associated with at least one of the segments of the audio/video stream that a receiving device is restricted from temporally moving through at a non-real time presentation rate;
processing the closed captioning data to identify the at least one video location;
identifying boundaries of the at least one of the segments of the audio/video stream based on the at least one video location;
receiving user input requesting to temporally move through the at least one of the segments of the audio/video stream at the non-real time presentation rate; and
outputting the at least one of the segments of the audio/video stream at a real-time presentation rate of the audio/video stream responsive to the user input.

11. The method of claim 10, wherein receiving the autonomous location information further comprises:
receiving the autonomous location information separately from the audio/video stream.

12. The method of claim 10, further comprising:
sorting the closed captioning data according to a presentation order of the closed captioning data; and
storing the sorted closed captioning data in a data file separate from the audio/video stream;
wherein processing the closed captioning data comprises lexically analyzing the sorted closed captioning data in the data file to identify the at least one video location.

13. The method of claim 10, wherein receiving the autonomous location information further comprises:
receiving at least one data segment contained in the closed captioning data;
receiving a beginning offset, associated with the at least one data segment, that is relative to the video location, the beginning offset identifying a beginning location of the at least one of the segments of the audio/video stream;
receiving an ending offset, associated with the at least one data segment, that is relative to the video location, the ending offset identifying an ending location of the at least one of the segments of the audio/video stream; and
receiving restriction data, associated with the at least one data segment, that indicates that the receiving device is restricted from temporally moving through the at least one segment at the non-real time presentation rate.

14. The method of claim 13, wherein the at least one data segment is unique within the at least one of the segments of the audio/video stream.

15. A receiving device comprising:
a communication interface that receives an audio/video stream including associated closed captioning data;
a storage unit that stores the audio/video stream;
control logic that:
receives autonomous location information separately from the audio/video stream, the autonomous location information referencing the closed captioning data to identify at least one video location within the audio/video stream;
processes the closed captioning data to identify the at least one video location;
identifies boundaries of multiple segments of the audio/video stream based on the at least one video location;
receives user input requesting to view at least one of the segments of the audio/video stream; and
an audio/video interface that outputs the at least one of the segments for presentation on a presentation device responsive to the user input.

16. The receiving device of claim 15, wherein the control logic sorts the closed captioning data according to a presentation order of the closed captioning data, stores the sorted closed captioning data in a data file separate from the audio/video stream, and lexically analyzes the sorted closed captioning data in the data file to identify the at least one video location.

17. The receiving device of claim 15, wherein the autonomous location information comprises at least one data segment contained in the closed captioning data, a beginning offset, associated with the at least one data segment, that is relative to the video location, the beginning offset identifying a beginning location of the at least one of the segments, and an ending offset, associated with the at least one data segment, that is relative to the video location, the ending offset identifying an ending location of the at least one of the segments of the audio/video stream.

18. The receiving device of claim 15, wherein the at least one data segment is unique within the at least one of the segments of the audio/video stream.

19. The receiving device of claim 18, wherein the audio/video interface generates a selection menu of the segments of the audio/video stream and the control logic receives a user selection of the at least one of the segments of the audio/video stream for output to the presentation device.

20. The receiving device of claim 19, wherein the audio/video interface generates the selection menu based on data associated with the autonomous location information.

21. The receiving device of claim 20, wherein the user selection designates a subset of the segments of the audio/video stream for presentation, and wherein the audio/video interface outputs the subset of the segments of the audio/video stream in an original temporal order, skipping output of undesignated segments of the audio/video stream.

22. The receiving device of claim 20, wherein the user selection designates a subset of the segments of the audio/video stream for presentation and a user-defined presentation order for the subset of the segments of the audio/video stream, and wherein the audio/video interface outputs the subset of the segments of the audio/video stream in the user-defined presentation order, skipping output of undesignated segments of the audio/video stream.

23. A receiving device comprising:
a communication interface that receives an audio/video stream including a plurality of segments and associated closed captioning data;
a storage unit that stores the audio/video stream;
control logic that:
receives autonomous location information referencing the closed captioning data to identify at least one video location within the audio/video stream, the video location associated with at least one of the segments of the audio/video stream that a user is restricted from temporally moving through at a non-real time presentation rate;
processes the closed captioning data to identify the at least one video location;
identifies boundaries of the at least one of the segments of the audio/video stream based on the at least one video location;
receives user input requesting to temporally move through the at least one of the segments of the audio/video stream at the non-real time presentation rate; and
an audio/video interface that outputs the at least one of the segments of the audio/video stream at a real-time presentation rate of the audio/video stream.

24. The receiving device of claim 23, wherein the autonomous location information is received separately from the audio/video stream.

25. The receiving device of claim 23, wherein the control logic sorts the closed captioning data according to a presentation order of the closed captioning data, stores the sorted closed captioning data in a data file separate from the audio/video stream, and lexically analyzes the sorted closed captioning data in the data file to identify the at least one video location.

26. The receiving device of claim 23, wherein the autonomous location information comprises at least one data segment contained in the closed captioning data, a beginning offset, associated with the at least one data segment, that is relative to the video location, the beginning offset identifying a beginning location of the at least one of the segments, and an ending offset, associated with the at least one data segment, that is relative to the video location, the ending offset identifying an ending location of the at least one of the segments.

27. The receiving device of claim 23, wherein the at least one data segment is unique within the at least one of the segments of the audio/video stream.
